(19) United States
(12) Patent Application Publication
(10) Pub. No.: US 2014/0315164 A1
(43) Pub. Date: Oct. 23, 2014

(54) SYSTEM AND METHOD FOR IMPROVING OPERATOR PERFORMANCE

(71) Applicant: CATERPILLAR INC., Peoria, IL (US)

(72) Inventors: Steven David JONES, Metamora, IL (US); Todd Bartholomew SMITH, Peoria, IL (US); Brad Robert VAN DE VEER, Washington, IL (US)

(73) Assignee: CATERPILLAR INC., Peoria, IL (US)

(21) Appl. No.: 13/864,573

(22) Filed: Apr. 17, 2013

(51) Int. Cl. G09B 5/00

(52) U.S. Cl. CPC G09B 5/00
USPC 434/219

(57) ABSTRACT

System and method for improving operator performance are provided. According to one embodiment, the method includes monitoring operation of a machine operated by an operator, analyzing performance of the operator based on the operation of the machine, rating the performance of the operator according to a plurality of skill levels, and adjusting capabilities of the machine according to the rating. Based on at least one of the analysis or the rating, the operator is provided with individualized guidance, which is configured to assist the operator to improve the performance of the operator.

### TECHNICAL FIELD

The present disclosure is directed to a system and method for improving operator performance.

### BACKGROUND

Proper operation of machinery, such as excavators, backhoe loaders, tractors, etc., by an operator is an important factor for improving productivity and safety at a work. site. Performance of the operator may be improved through extensive training conducted in simulated environments or on training devices. U.S. Pat. No. 6,033,226 discloses an interactive multimedia training system, which incorporates text, audio, and video graphics animation to teach an operator to use a machine. The training system may serve as a quick reference guide and provide insight into the tooling process by use of simulations. It may allow the user to walk through and practice the tooling operation for a particular part and gain expert advice on what common errors should be avoided. Additionally, the training system may serve as a self-testing device, which allows the user to test their knowledge of a particular process. A profile or history of each operator can be reviewed by an instructor or supervisor to aid in the training process.

Although training may improve the operator's performance before the operator is assigned to a field, training may not cover the diverse situations encountered in the field. Thus, productivity and safety may be compromised because the operator has no guidance to handle a particular situation in his/her day-to-day operation in the field. For example, improper operation by an operator tends to subject a machine to excessive stresses or overloads, causing early fatigue or failure of certain components. In addition, it is often difficult and costly to recreate a certain situation or scenario in a training program for an operator to practice a particular procedure.

Moreover, existing training and performance evaluation systems may not provide adequate feedback on an operator's performance. For example, existing systems may lack mechanisms to show differences between an operator's own performance and a desired performance. The existing systems may also fail to adapt to a particular operational situation, a particular procedure, an underlying machine, or the operator's skill level. The existing training systems ma also fail to provide adequate incentives or guidance to the operators to improve in a particular area or procedure in operating a machine. The disclosed system is directed to overcoming one or more of the shortcomings in existing technology.

### SUMMARY

According to one embodiment of the disclosure, a method for improving operator performance is provided. The method includes monitoring operation of a machine operated by an operator, analyzing performance of the operator based on the operation of the machine, rating the performance of the operator according to a plurality of skill levels, and adjusting capabilities of the machine according to the rating. Based on at least one of the analysis or the rating, the operator is provided with individualized guidance, which is configured to assist the operator to improve the performance of the operator.

According to another embodiment, a system for improving operator performance is provided. The system includes one or more input devices, one or more output devices, and a control circuit. The one or more input devices are configured to receive operator inputs from an operator for operating a machine. The control circuit is configured to monitor operation of the machine, analyze performance of the operator based on the operation of the machine, rate the performance of the operator according to a plurality of skill levels, and generate signals representing individualized guidance to the operator based on at least one of the analysis or the rating. The one or more output devices are configured to receive the signals from the control circuit and provide the individualized guidance to the operator during the operation of the machine. The individualized, guidance is configured to assist the operator to improve the performance.

According to still another embodiment, a computer-readable medium is provided. The computer-readable medium includes computer executable instructions, which, when executed by a processor, causes the processor perform a method for improving operator performance. The method includes monitoring operation of a machine operated by an operator, analyzing performance of the operator based on the operation of the machine, rating the performance of the operator according to a plurality of skill levels, and adjusting capabilities of the machine according to the rating. Based on at least one of the analysis or the rating, the operator is provided with individualized guidance, which is configured to assist the operator to improve the performance of the operator.

### BRIEF DESCRIPTION OF THE DRAWINGS

FIG. 1 is a diagram of an exemplary disclosed system for improving operator performance;

FIG. 2 is a diagram of another exemplary disclosed system for improving operator performance; and

FIG. 3 is a flow chart illustrating an exemplary process for improving operator performance.

### DETAILED DESCRIPTION

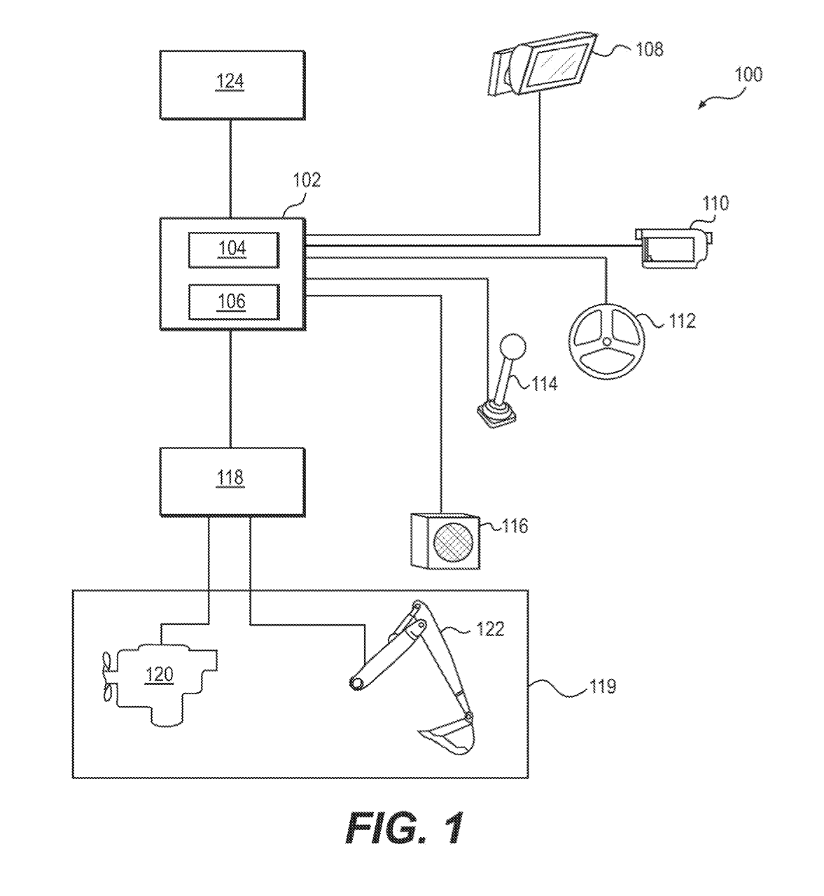

FIG. 1 illustrates a diagram of an exemplary disclosed system 100 for improving operator performance in operating a machine 119. Machine 119 may be any machine known in the art, such as an excavator, a backhoe loader, a tractor, a bulldozer, an automobile, or an airplane. System 100 includes a control circuit 102 having a processor 104 and a memory 106. Processor 104 may be a central processing unit (CPU) known in the art, such as an INTEL processor or an AMD processor. Memory 106 may he a ROM, a RAM, a flash memory, a hard drive, or other computer-readable media known in the art. Memory 106 may store computer-executable instructions, which may be executed by processor 104 to perform the processes described herein to improve an operator's performance during operation of machine 119, Memory 106 may further store data relevant to the processes described herein, such as data representing operator inputs, operator performance, and operational status of machine 119 in various situations or under various conditions.

System 100 further includes one or more user input/output devices, such as a display device 108, a camera 110, a steering wheel 112, a control handle 114, a speaker 116, or other input/output devices known in the art. The user input/output devices may be coupled to control circuit 102 through their respective connections.

Some of the user input/output devices, such as camera 110, may be exclusive input devices configured to provide input signals to control circuit 102. Some other user input/output devices, such as speaker 116, may be exclusive output devices configured to receive output signals from control circuit 102 and provide guidance to the operator according to the output signals from control circuit 102. Still some other user input/output devices, such as display device 108, steering wheel 112, and handle 114, may provide input signals to control circuit 102 as well as receive output signals from control circuit 102. Through the user input/output devices, control circuit 102 may detect and monitor performance of an operator operating machine 119 and interact with the operator to provide guidance to the operator during the operation of machine 119. Additionally, control circuit 102 may monitor operation of machine 119 and identify types of operation of machine 119. For example, control circuit 102 may identify whether machine 119 moves forward or backward or whether a linkage of machine 119 is raised or lowered.

In particular, the input signals received by control circuit 102 may represent a wide range of information. For example, control circuit 102 may receive video signals from camera 110, which capture images or videos of a field in which machine 119 is operated. The field may be a construction site, a mining site, or other predetermined area. Control circuit 102 may also receive input signals from, for example, steering wheel 112 or handle 114, indicating an operator input or an operational commands provided by the operator. Control circuit 102 may also receive input signals from other input devices, such as a button or a pedal, as known in the art.

Similarly, the output signals provided by control circuit 102 may also represent a wide range of information The input/output devices may convert the output signals to guidance for the operator. For example, control circuit 102 may generate a visual feedback including a graphical interface through display device 108 for guiding the operator in operating machine 119. Control circuit 102 may generate haptic feedback through steering wheel 112 or handle 114, providing indications to the operator about a desired input or guiding the operator through a desired operation. Still further, control circuit 102 may generate a sound feedback including audible sounds through speaker 116, providing voice guidance to the operator in operating machine 119.

According to a further embodiment, the guidance generated by system 100 may be instantaneous. Additionally, the guidance provided by system 100 may be based on the operator inputs, the operation of machine 119, and information of the underlying task or procedure. Thus, the guidance provided by system 100 may be individualized to suit the needs of different operators.

Control circuit 102 may be further coupled to a controller 118. Controller 118 may be associated with or integrated in machine 119. Controller 118 is configured to control various components of machine 119, such as engine 120 or linkage 122, according to inputs from the operator. For example, when the operator pushes or pulls control handle 114, controller 118 may cause linkage 122 to extend or move in a particular manner. When the operator turns steering wheel 112, controller 118 may cause machine 119 to turn.

Controller 118 may receive the commands or operator inputs from the operator through control circuit 102 or through other means known in the art. Controller 118 may also provide signals to control circuit 102 indicating the operational status or operational parameters of machine 119 or components thereof, such as engine 120 and linkage 122. For example, controller 118 may report to control circuit 102 about a rotational speed or an operational temperature of engine 120 or a position or an orientation of linkage 122. According to additional embodiments, controller 118 may also report to the control circuit 102 about a traveling speed of machine 119, a pressure of a hydraulic system of machine 119, a voltage of a battery of machine 119, or any other operational parameters of machine 119.

Upon receiving the signals from controller 118, control circuit 102 may store the signals in memory 106 and analyze the signals using processor 104. For example, control circuit 102 may compare the operational status of machine 119 indicated by the signals from controller 118 and desired operational status stored in memory 106. Based on the comparison results, control circuit 102 may evaluate the performance of the operator.

For example, control circuit 102 may rate or categorize the performance of the operator based on the deviation of the operational status of the machine from the desired operational status. Control circuit 102 may assign the performance of the operator to one of a plurality of categories or skill levels based on the comparison result. Control circuit 102 may rate the operator as a novice operator, a skilled operator, or an expert operator. Control circuit 102 may indicate the skill levels using numerical or alphabetical indicators, such as “Level 1,” “Level 2,” “Level 3,” “Level A,” “Level B,” or “Level C.” Control circuit 102 may store data representing any number of skill levels.

According to an alternative embodiment, control circuit 102 may monitor and evaluate the performance of the operator by comparing the inputs from the operator with desired inputs stored in memory 106 corresponding to a given situation or operational status of the machine. For example, based on the operational status received from controller 118, control circuit 102 may determine desired inputs, such as a desired movement of handle 114 or steering wheel 112. Control circuit 102 may then compare the desired inputs with the actual inputs provided by the operator. Based on the deviation of the inputs provided by the operator from the desired inputs, control circuit 102 may rate or categorize the performance of the operator to one of the skill levels.

According to a further embodiment, control circuit 102 may provide guidance to the operator according to, for example, the operational status of the machine, the inputs received from the operator, or the skill level of the operator as determined above. Control circuit 102 may provide the guidance to the operation in various means.

For example, control circuit 102 may generate videos or images through display device 108 to provide visual feedback to the operator about his/her performance. The visual feedback displayed on display device 108 may include. for example, an indication of desired inputs for a given operational status of the machine or a difference between the actual inputs provided by the operator and the desired inputs. More specifically, display device 108 may indicate to the operator a desired position of handle 114 or steering wheel 112 for a given operational status of machine 119. Display device 108 may also show a difference between the desired position and a current actual position of handle 114 or steering wheel 112. Furthermore, display device 108 may provide guidance to the operator, through text or graphical means, to guide the operator to adjust the actual inputs and to minimize the difference between the desired inputs and the actual inputs.

Additionally or alternatively, the visual feedback provided by control circuit 102 may further indicate to the operator differences between desired operational parameters of machine 119 and current actual operational parameters. For example, display device 108 may show a desired position of linkage 122, a desired traveling speed of the machine, a desired rotational speed of engine 120, etc., and the actual values of the corresponding parameters.

Still additionally, control circuit 102 may render the videos or images captured by camera 110 on display device 108 along with, for example, a desired position of linkage 122 for guiding the operator. As a result, the visual feedback on display device 108 provides a direct comparison between the current position and the desired position of linkage 122 and allows the operator to adjust the inputs to minimize the difference.

According to an alternative embodiment, the visual feedback may be rendered on a heads-up display (HUD) system embedded or integrated in, for example, a windshield of the machine. The HUD system may allow the operator to maintain his/her focus on the field while receiving guidance through system 100.

Based on the visual feedback on display device 108, the operator may adjust the inputs to minimize the differences between the desired operational parameters and the actual operational parameters. For example, the operator may adjust handle 114, steering wheel 112, a pedal, or other input mechanisms.

Additionally or alternatively, control circuit 102 may generate haptic feedback to guide the operator through an operational procedure. For example, based on the comparisons described above and the skill level of the operator, control circuit 102 may render the haptic feedback through handle 114, steering wheel 112, a pedal, or a button, and suggest to the operator a particular movement of handle 114, steering wheel 112, or the pedal. Upon receiving the haptic feedback, the operator may follow the suggestion to adjust handle 114, steering wheel 112, the pedal, or the button, to achieve the desired operational status of machine 119.

Still additionally or alternatively, control circuit 102 may generate voice feedback to guide the operator through the operational procedure. For example, based on the comparisons described above and the skill level of the operator, control circuit 102 may render the voice feedback through speaker 116, guiding the operator to achieve the desired operational status of machine 119. Other means, as known in the art, for generating feedback and providing guidance to the operator may also be used by control circuit 102.

According to a still further embodiment, control circuit 102 may employ gamification principles to provide incentives for the operators of the machine to improve their skill levels and to improve efficiency of the machine. In particular, control circuit 102 may monitor the skill level of the operator and provide rewards to the operator when there are improvements in the skills of the operator. The skill level of the operator may be represented by numerical indicators, such as “1,” “2,” and “3,” or alphabetical indicators, such as “A,” “B,” and “C,” as described above, or other indicators, such as color codes, as known in the art.

Each skill level represents the operator's familiarity with the machine or the performance of the operator in operating machine 119. Control circuit 102 may determine the skill level of the operator by, for example, comparing the performance of the operator with desired performance, such as an expert's performance. Control circuit 102 may also determine the skill level of the operator according to errors or mistakes detected during the operation of the machine by the operator. In general, the greater the deviation of the performance of the operator from the desired performance, or the more errors detected in the operation of the machine, the less experienced skill level is associated with the operator. Alternatively, control circuit 102 may determine the skill level of the operator through, for example, explicit user inputs or third-party information provided by, for example, an employer of the operator, a professional association to which the operator belongs, a manufacturer, a dealer, or an owner of machine 119.

According to a further embodiment, control circuit 102 may adjust the skill level associated with the operator during the operation of the machine according to changes in the performance of the operator. For example, when the operator improves his/her performance, control circuit 102 may detect a reduction in the difference between the desired performance and the performance of the operator or the errors made by the operator, control circuit 102 may adjust the skill level of the operator to a more experienced skill level.

Additionally, control circuit 102 may provide rewards to the operator according to the performance of the operator. For example, control circuit 102 may institute a point system by assigning a number of points to the operator. Control circuit 102 may reward the operator with more points when the operator improves his/her performance. When the number of points awarded to the operator reaches a predetermined threshold value, control circuit 102 may associate the operator with a relatively more experienced skill level. Additionally, control circuit 102 may provide visual displays, sound effects, or vibrations through the input/output devices to recognize the improvement of the operator.

Still additionally or alternatively, control circuit 102 may adjust the capabilities of machine 119 available to the operator according to the skill level of the operator. For example, control circuit 102 may adjust the capabilities by limiting the capabilities of machine 119 through, for example, controller 118, when the operator is at a relatively inexperienced skill level. More specifically, when the operator is at the relatively inexperienced skill level, control circuit 102 may limit, for example, the power of machine 119 or engine 120 to a predetermined percentage (e.g., 80%) of its full power or the traveling speed of the machine to a predetermined percentage of its maximum allowable speed. Alternatively, control circuit 102 may limit the number of procedures or the range of motions that may be performed by machine 119 or linkage 122. Still alternatively, control circuit 102 may limit the pressure generated by a hydraulic system of machine 119 or a maximum load allowed to be borne by machine 119. Other means of limiting the capabilities of machine 119 may also be used.

As the operator advances to relatively more experienced skill levels, control circuit 102 may gradually relax the limits on the capabilities of the machine and make greater capabilities available to the operator. For example, when the operator reaches a relatively more experienced skill level, control circuit 102 may instruct controller 118 to allow the machine to operate at its full power, to travel at its maximum allowable speed, to move within its full range of motions, to carry the maximum allowable load, or to have other capabilities not fully available to the operator when the operator is at the relatively inexperienced skill level.

Still alternatively, control circuit 102 may include a plurality of operator accounts for different operators, respectively. Each account may include an indication of the skill level associated with the individual operator. Control circuit 102 may assign a predetermined skill level of the operator when the operator opens an account with system 100. Control circuit 102 may require an operator to sign into his/her own account before operating the machine. Thus, control circuit 102 may institute the point system for the multiple operators and monitor the skill levels of the multiple operators operating the same machine

Control circuit 102 may rank the operators according to the points they have earned and/or their skill levels. Upon request, control circuit 102 may display the ranking of a particular operator with respect to other operators, thereby providing a competitive environment that gives incentives to the operators to improve their skill levels. Additionally, control circuit 102 may rank the performance of the operators with respect to different skill sets in operating the machine, thereby providing incentives to the operators to improve their skill levels in individual skill sets. Still alternatively, control circuit 102 may monitor the performance of a given operator in operating, different types of machines and rank the skill levels of the operator with respect to the different types of machines, thereby providing the operator with incentives to improve his/her skill level for a particular type of machine.

Additionally, control circuit 102 may configure machine 119 to operate in a plurality of modes, such as a learning mode and a working mode in the learning mode, control circuit 102 may engage the gamification principles and performance monitoring functions described above. In the working mode, control circuit 102 may allow the operator to operate machine 119 without any restrictions or limitations associated with the learning mode. Control circuit 102 may switch machine 119 between the learning mode and the working mode according to user inputs. For example, control circuit 102 may include user input devices as known in the art, such as a keyboard, a mouse, or a touch pad, which allows a user to control operation of control circuit 102. Thus, control circuit 102 allows policing the use of the machine by the operator, an owner, a manufacturer, a dealer, or other parties known in the art.

According to an additional embodiment, control circuit 102 may be coupled to a computer system 124 through a wired or wireless connection. Computer system 124 may be located remotely from control circuit 102 or machine 119. Computer system 124 may store data indicating a profile of the operator and a track record of the operator in operating machine 119. Computer system 124 may also include data indicating the desired operational status or parameters of the machine in various situations or conditions. Control circuit 102 may collect the data indicating the performance of the operator, the skill level of the operator, or the operational status of the machine, and transmit the data to computer system 124. Computer system 124 may then provide the performance monitoring functions and apply the gamification principles described above in connection with control circuit 102.

According to a further embodiment, computer system 124 may be associated with an employer of the operator or an owner, a manufacturer, or a dealer of machine 119. When computer system 124 determines, based data transmitted from control circuit 102, that the operator advances to a relatively more experienced skill level in operating machine 119, computer system 124 may generate a certificate for the operator, which recognizes the achievement of the operator. The certificate may be mailed to the operator or awarded to the operator by the employer, the owner, the manufacturer, or the dealer. Alternatively, computer system 124 may generate a monetary award or other types of awards for the operator.

Although control circuit 102, controller 118, and computer system 124 are shown as separate entities in FIG. 1, they may be integrated in a single hardware system, For example, controller 118 may be on-board machine 119, while control circuit 102 or computer system 124 may be implemented in a form of appropriate software or hardware modules included in controller 118. Alternatively, control circuit 102 and computer system 124 may be implemented as stand-alone modules coupled to controller 118 through appropriate interfaces as is known in the art.

Still alternatively, computer system 124 may communicate with a plurality of machines having control circuits similar to control circuit 102. Computer system 124 may receive data indicating performance of the operators operating the plurality of machines from the associated control circuits, respectively. Computer system 124 may allow sharing of the data among multiple machines. Computer system 124 may monitor the performance of the operators in operating the machines. Computer system 124 may also guide the operators through various procedures by using, for example, visual feedback, haptic feedback, or voice feedback, as discussed above. Computer system 124 may also apply the gamification principles to provide incentives, such as awards or recognitions, for the operators to improve their performance as discussed above.

### INDUSTRIAL APPLICABILITY

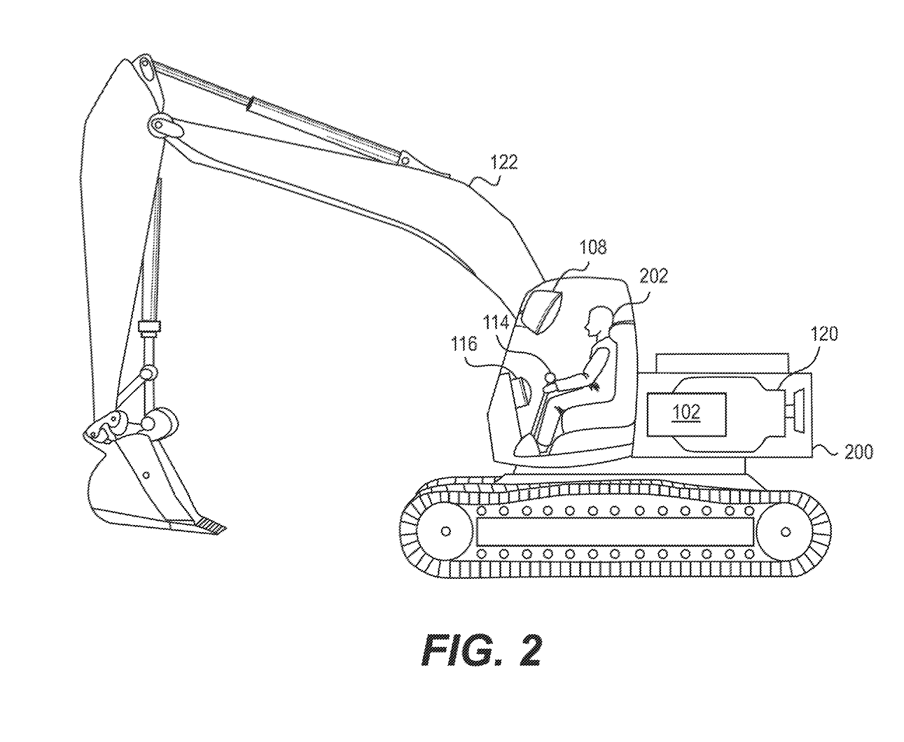

System 100 described above in connection with FIG. 1 may be used to improve performance of an operator in operating any machine known in the art. FIG. 2 illustrates an embodiment of an excavator 200 with system 100 integrated therein. The same reference numerals in FIGS. 1 and 2 refer to like elements.

In particular, operator 202 may control excavator 200 through various control mechanisms, such as handle 114, steering wheel 112, buttons, or pedals. Operator 202 may provide control commands or inputs through the control mechanisms for controlling the operation of excavator 200 as required by underlying tasks or procedures in a field, in a controlled training process, or in a simulated environment.

Control circuit 102 may monitor operation of excavator 200 and the performance of operator 202 as described above and provide guidance to the operator 202 through various output devices including, for example, display device 108, handle 114, and speaker 116. Control circuit 102 may generate visual, haptic, or sound feedback through the output devices to guide operator 202 through a procedure, according to the skill level of operator 202, the control commands from operator 202, the operational parameters of excavator 200, the task or procedure, or other factors known in the art. Thus, system 100 provides instantaneous feedback to operator 202 and acts as a “virtual mentor” for operator 202 during a procedure.

As described above, control circuit 102 may employ the gamification principles to provide incentives for operator 202 to improve his/her skill level in operating excavator 200. Control circuit 102 may institute a point system and award points to operator 202 when operator 202 improves his/her performance. Control circuit 102 may assign an indicator indicating the skill level of operator 202. As operator 202 improves his/her skills in operating excavator 200, control circuit 102 may adjust the indicator to reflect the improvement. In addition, system 100 may award operator 202 a certificate or recognition as operator 202 reaches a new skill level. Still additionally, system 100 may manage a plurality of operator accounts for different operators operating excavator 200. System 100 may rank operator 202 with respect to other Operators and provide incentives to operator 202 to improve his/her ranking.

Additionally, control circuit 102 may adjust capabilities of excavator 200 according to the skill level of operator 202. When operator 202 is associated with a relatively inexperienced skill level, control circuit 102 may adjust the capabilities by limiting the capabilities of excavator 200 to a portion of its full capabilities. For example, control circuit 102 may adjust the power of linkage 122 to a percentage of its full power by adjusting a pressure of a hydraulic system of excavator 200 to a percentage of a maximum allowable pressure. Alternatively, control circuit 102 may adjust a speed of linkage 122 to a percentage of its maximum speed by adjusting a flow rate of the hydraulic system of excavator 200 to a percentage of a maximum allowable flow rate. Control circuit 102 may use other means to limit the capabilities of excavator 200. When operator 202 advances to relatively more experienced skill levels, control circuit 102 may gradually adjust the limits on the capabilities of excavator 200 by increasing the capabilities. When operator 202 reaches an expert level or the most experienced skill level, for example, control circuit 102 may remove the limits entirely and allow excavator 200 to be operated at its full capacity.

Still additionally, control circuit 102 may control excavator 200 to operate in a plurality of modes, such as a learning mode and a working mode. In the learning mode, control circuit 102 may perform the performance monitoring function, provide the “virtual mentor,” or employ the gamification principles as described above. In the working mode, control circuit 102 may terminate the adjustment to the capabilities of excavator 200 and allow excavator 200 to be operated without any limitations of the learning mode. Control circuit 102 may also allow operator 202 or other persons, such as an owner, a manufacturer, or a dealer of excavator 200, to switch excavator 202 between the learning mode and the working mode as desired.

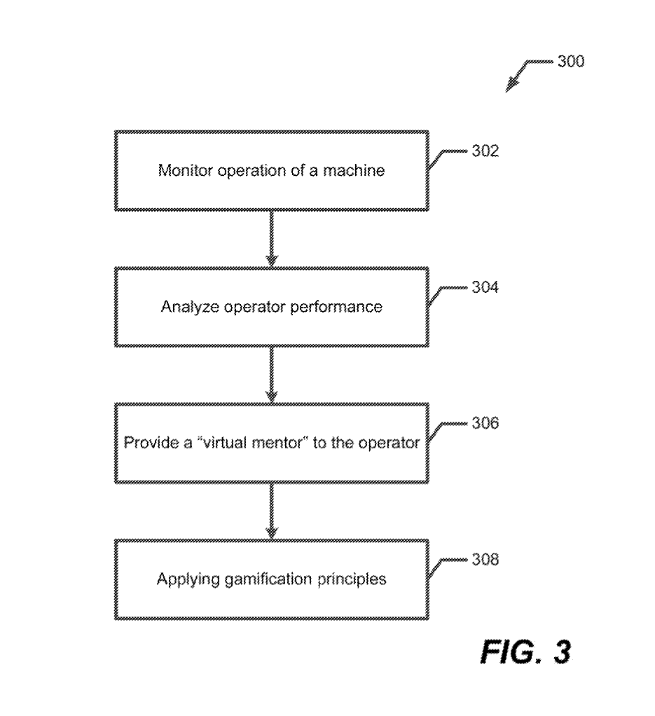

FIG. 3 illustrates a flow chart of an exemplary process 300 for improving operator performance in operating a machine. Process 300 may be implemented in for example, system 100 of FIG. 1 to improve the operator performance in operating any type of machine as described above. According to process 300, at step 302, control circuit 102 may monitor operation of the machine and performance of an operator operating the machine. The operator may control the machine through a number of control mechanisms known in the art, such as, a steering wheel, a handle, a button, or a pedal. Control circuit 102 may monitor commands or inputs received from the operator through the control mechanisms, For example, control circuit 102 may monitor a rotation of the steering wheel or a movement of the handle.

At step 304, control circuit 102 may analyze the performance of the operator in operating the machine. Control circuit 102 may analyze the performance of the operator based on a number of factors including, for example, the commands received from the operator, desired commands expected from the operator, operational parameters of the machine collected by a controller of the machine, desired operational parameters of the machine pre-stored in control circuit 102, tasks or procedures being carried out by the machine, and environmental parameters, such as temperature, pressure, or humidity.

In particular, control circuit 102 may store the desired commands expected from the operator and the desired operational parameters of the machine corresponding to a particular procedure and environmental parameters. The desired commands and desired operational parameters may be obtained based on operation of the machine by a person with an expert skill level (e.g., the most experienced skill level). Thus, the desired commands and desired operational parameters may represent the expert skill level, towards which the operator is encouraged to advance.

During the operation of the machine, control circuit 102 may compare the actual commands received from the operator and the desired commands expected from the operator. Control circuit 102 may also compare the actual operational parameters detected from the machine and the desired operational parameters.

At step 306, control circuit 102 may generate a “virtual mentor” to the operator based on the analysis at step 304 to improve his/her performance in operating the machine. The “virtual mentor” refers to guidance or feedback to the operator provided by control circuit 102 through various feedback mechanisms, such as display device 108, steering wheel 112, handle 114, or speaker 116, Control circuit 102 may include artificial intelligence to customize the “virtual mentor” for individual operators, according to their skill levels, the underlying tasks and procedures, the types of machine, and other factors, such as environmental parameters.

Through the “virtual mentor,” control circuit 102 may provide individualized, instantaneous instructions to the operator to improve his/her performance with respect to specific operational steps or procedures. Control circuit 102 may also provide customized guidance or advice to the operator in operating the machine. Thus, from the operator's point of view, the “virtual mentor” has intelligence similar to a person with the expert skill level guiding the operator during the operation of the machine.

In particular, control circuit 102 may provide the “virtual mentor” in the form of visual feedback through display device 108. The visual feedback may include, for example, text, images, or videos. According to one embodiment, the visual feedback may show differences between the commands received from the operator and the pre-stored desired commands or differences between the operational parameters detected from the machine and the desired operational parameters. The visual feedback may also include text displayed through a display device, comparing, for example, a current rotational speed and a desired rotational speed of engine 120. The visual feedback may also include images or videos showing a comparison between a current position of linkage 122 and a desired position of linkage 122.

Control circuit 102 may also provide the “virtual mentor” in the form of haptic feedback through the control mechanisms, such as steering wheel 112 or handle 114. The haptic feedback may include, for example, vibrations, forces, or motions. For example, control circuit 102 may cause steering wheel 112 to turn in a particular direction or to vibrate, guiding the operator to provide a particular command through steering wheel 112. Alternatively, control circuit 102 may cause handle 114 to move in a particular manner, guiding the operator to provide a particular command through handle 114. Similar haptic feedback may also he provided through other means known in the art, such as buttons, pedals, or seats.

Control circuit 102 may also provide the “virtual mentor” in the form of sound feedback through speaker 116 The sound feedback may include voice guidance suggesting the operator to provide particular commands.

At step 308, control circuit 102 may apply gamification principles to provide incentives for the operator to improve his/her performance. Control circuit 102 may employ a point system to monitor the improvement of the performance of the operator. For example, control circuit 102 may store an account of the operator and add points to the operator's account when the commands from the operator are sufficiently close to the desired commands. Control circuit 102 may also subtract points from the operator's account when the operator provides incorrect or undesired commands.

Control circuit 102 may also institute a hierarchical structure including a plurality of skill levels from a least experienced skill level to a most experienced skill level (e.g., an expert skill level). Initially, control circuit 102 may associate the operator with one of the skill levels, such as the least experienced skill level. When points awarded to the operator in the account reach a threshold value, control circuit 102 may advance the operator towards a relatively more experienced skill level. Control circuit 102 may designate the skill levels with numerical or alphabetical references as described above.

Additionally, when the operator reaches a new skill level, control circuit 102 may generate congratulatory images, sounds, or other feedback to recognize the improvement of the operator's performance. Additionally, control circuit 102 may generate an award or a certificate to be sent to the operator in recognition of the improvement. Still additionally, control circuit 102 may notify a third party, such as an employer of the operator, a professional association of the operator, or an owner, a manufacturer, or a dealer of the machine about the improvement of the operator's performance. The third party may grant an award, issue a certificate, or provide monetary awards to the operator in recognition of the improvement.

Still additionally, control circuit 102 may store a plurality of accounts associated with different operators operating the machine. Control circuit 102 may compare the performance and skill levels of the operators and rank the operators according to their performance and/or skill levels. As part of the incentives to the operators, control circuit 102 may provide the ranking to the operator, creating a competitive environment, which gives incentives to the operator to improve their performance and skills.

The system and method described above provide personalized or individualized guidance to assist the individual operator in operating the machine. The individualized guidance is generated according to at least one of the skill levels associated with the individual operator, the operational status of the machine, and the underlying procedure performed by the machine. The system may create a competitive environment and provide incentives for the operators to improve their skills. The system may compare the performance of the operator with that of other operators and provide the comparison results to the operator as part of the feedback. The system may also adjust the capabilities of the machine according to the skill level or performance of the operator and increase the capabilities of the machine when the performance of the operator is improved.

As a result, the system allows the operator of the machine to quickly improve his/her performance and skills during day-to-day operation of the machine. The guidance and feedback provided by the system are instantaneous, so that the operator may correct the inputs during the operation of the machine. Thus, the learning period required for operating the machine may be significantly shortened, compared with conventional training systems. The efficiency and productivity of the machine may be significantly improved and the costs of operating and maintaining the machine may he substantially reduced.

Because the system may adjust the capabilities of the machine according to the skill level or performance of the operator, the system may also improve work-site safety and reduce machine abuse. In particular, when system 100 determines that the operator is at a relatively inexperienced skill level, it may restrict the capabilities of the machine by limiting, for example, the maximum power, the maximum pressure, or the maximum speed of the machine or the maximum operational range allowed for a linkage of the machine. Alternatively, system 100 may limit the number of procedures available to the operator by allowing, for example, a limited number of motions of the linkage. System 100 may also similarly restrict the capabilities of the machine when determining that the operator's performance is below a certain skill level because of, for example, incorrect user inputs or a tendency to abuse the machine

When the operator advances to a relatively more experienced skill level by improving, his/her skills or refraining from engaging in abusive operation, system 100 may gradually relax the restrictions on the capabilities of the machine. Depending on the skill level of the operator, for example, system 100 may increase the maximum power, the maximum pressure, or the maximum speed of the machine. System 100 may also increase the maximum operational range of the linkage or the number of motions of the linkage. As a result, the operator is allowed to operate the machine to achieve a greater number of procedures or tasks. System 100 may notify the operator about the advancement so that the operator may apply the new capabilities of the machine if desired.

By adjusting the capabilities of the machine, system 100 may limit how the operator is allowed to operate the machine or what work the machine is able to perform under the operation of the operator. Thus, system 100 may prevent the operator from accidentally or intentionally overloading the machine, abusing the machine, or operating the machine in an inappropriate manner that may compromise the safety at a work site. In addition, because the operator is allowed to use only a portion of the full capabilities of the machine when he/she is relatively inexperienced or has a tendency to engage in abusive operation, the machine is protected from unnecessary damage.

It will be apparent to those skilled in the art that various modifications and variations can be made to the disclosed system. Others embodiments will be apparent to those skilled in the art from consideration of the specification and practice of the disclosed system. It is intended that the specification and examples be considered as exemplary only, with a true scope being indicated by the following claims and their equivalents

What is claimed is:

1. A method for improving operator performance, comprising:
monitoring operation of a machine operated by an operator;
analyzing performance of the operator based on the operation of the machine;
rating the performance of the operator according to a plurality of skill levels;
adjusting capabilities of the machine according to the rating; and
providing individualized guidance to the operator during the operation of the machine based on at least one of the analysis or the rating, the individualized guidance being configured to assist the operator to improve the performance.

2. The method of claim 1, wherein providing the individualized guidance includes providing the operator with at least one of visual feedback, haptic feedback, and sound feedback.

3. The method of claim 2, wherein the individualized guidance includes information about differences between an input from the operator and a desired input.

4. The method of claim 2, wherein the haptic feedback includes a suggestion to the operator to provide a desired input.

5. The method of claim 1, further comprising:
awarding the operator with a number of points when the performance of the operator is improved.

6. The method of claim 5, farther comprising awarding the operator with additional points when the operator provides an input to the machine substantially similar to a desired input.

7. The method of claim 6, wherein rating the performance of the operator further comprises associating the operator with one of the skill levels according to the number of points awarded to the operator.

8. The method of claim 7, wherein the skill levels include at least a least experienced skill level and a most experienced skill level, and
the method further comprises advancing the skill level associated with the operator towards the most experienced skill level when the points awarded to the operator reach a predetermined number of points.

9. The method of claim 8, further comprising providing recognition to the operator when the operator advances to a new skill level.

10. The method of claim 9, wherein the recognition includes at least one of a certificate or a monetary award.

11. The method of claim 8, further comprising:
adjusting capabilities of the machine to a portion of its full capabilities when the operator is associated with a relatively inexperienced skill level;
increasing the capabilities of the machine when the operator advances towards the most experienced skill level; and
providing the full capabilities of the machine when the operator reaches the most experienced skill level.

12. The method of claim 1, further comprising:
setting the machine to operate in one of a learning mode and a working mode;
adjusting the capabilities of the machine according to a skill level of the operator when the machine is set to the learning mode; and
terminating the adjustment to the capabilities of the machine when the machine is set to the working mode.

13. The method of claim 1, further comprising:
monitoring performance of a plurality of operators operating the machine;
ranking the performance of the plurality of operators; and
providing the ranking to the operators as part of the guidance.

14. The method of claim 1, further comprising:
transmitting information about the performance of the operator to a remote computer for remote monitoring.

15. The method of claim 14, wherein the remote computer is associated with at least one of an employer of the operator or an owner, a manufacturer, or a dealer of the machine.

16. A system for improving operator performance, comprising:
one or more input devices configured to receive operator inputs from an operator for operating a machine;
a control circuit configured to monitor operation of the machine, analyze performance of the operator based on the operation of the machine, rate the performance of the operator according to a plurality of skill levels, and generate signals representing individualized guidance to the operator based on at least one of the analysis or the rating; and
one or more output devices configured to receive the signals from the control circuit and provide the individualized guidance to the operator during the operation of the machine, the individualized guidance being configured to assist the operator to improve the performance.

17. The system of claim 16, wherein the control circuit is further configured to adjust capabilities of the machine according to the rating.

18. The system of claim 16, wherein the control circuit is further configured to:
associate the operator with one of the skill levels; and
adjusting capabilities of the machine when the operator advances through the skill levels.

19. The system of claim 16, wherein the control circuit further transmits additional signals to a remote computer system for remote monitoring, the additional signals representing the performance of the operator.

20. A computer-readable medium including computer executable instructions, which, when executed by a processor, causes the processor to perform a method for improving operator performance, the method comprising:
monitoring operation of a machine operated by an operator;
analyzing performance of the operator based on the operation of the machine;
rating the performance of the operator according to a plurality of skill levels;
adjusting capabilities of the machine according to the rating; and
providing individualized guidance to the operator based on at least one of the analysis or the rating during the operation of the machine, the individualized guidance being configured to assist the operator to improve the performance.
